(19) United States
(12) Patent Application Publication
(10) Pub. No.: US 2011/0276988 A1
(43) Pub. Date: Nov. 10, 2011

(54) OPTICAL DISC DRIVE

(76) Inventors: Po-Hsiang Huang, Pingtung County (TW); Yuh Cheng, Hsinchu County (TW); Hao-Hui Yin, Hsinchu City (TW); Li-Chun Yang, Tainan (TW)

(21) Appl. No.: 13/091,157

(22) Filed: Apr. 21, 2011

Related U.S. Application Data
(60) Provisional application No. 61/332,208, filed on May 7, 2010.

(51) Int. Cl. G11B 17/04

(52) U.S. Cl. 720/601; G9B/17.013

(57) ABSTRACT

An optical disc drive includes a housing, a disc tray, a connector, a spindle motor, an OPU, a motor drive, and a control circuit. The disc tray may slide into or out of the housing through its opening. The connector is installed on the housing for transmitting host signals to the disc tray. The control circuit is installed on the disc tray for processing the host signals, thereby operating the spindle motor and the OPU accordingly.

### CROSS REFERENCE TO RELATED APPLICATIONS

This application claims the benefit of U.S. Provisional Application No. 61/332,208 filed on May 7, 2010, the contents of which are incorporated herein in their entirety.

### BACKGROUND OF THE INVENTION

1. Field of the Invention

The present invention is related to an optical disc drive, and more particularly, to a low-cost optical disc drive providing large return loss margin.

2. Description of the Prior Art

Recently, the general trends in designing optical disc drives are toward small size, light weight and easy portability. In comparison with the half-height optical disc drive conventionally used in the desktop computers, the slim-type optical disc drive is widely used in notebook computers due to the reduced volume and its light weight.

A prior art optical disc drive includes a housing, and a disc tray for loading a disc into the housing for subsequent reading/writing operations. An optical pickup unit (OPU) for accessing data from the disc and a spindle motor for spinning the disc are installed on the disc tray. A main board is attached to the housing for containing a motor driving circuit and a control circuit. High-speed connectors, such as serial advanced technology attachment (SATA) connectors, are mounted on the main board and the disc tray for receiving host signals and intercommunicating between the main circuit board, the OPU and the spindle motor. After processing the host signals, the motor driving circuit and the control circuit then transmit related signals to the disc tray via corresponding connectors and flexible cable for operating the spindle motor and the OPU. Since the host signals are processed before being transmitted to each unit on the disc tray, the connectors and cables require a large number of pins.

### SUMMARY OF THE INVENTION

The present invention provides an optical disc drive including a housing; a disc tray which capable of sliding into and out of the housing; a first circuit board mounted on the disc tray; a first connector on the housing for receiving a host signal; a control circuit on the first circuit board for processing the host signal; and a signal transmitting medium electrically interconnected between the first connector and the first circuit board.

The present invention also provides an optical disc drive, including a housing; a disc tray which capable of sliding into and out of the housing; and a signal transmitting medium configured to provide a signal transmission path between the housing and the disc tray and having an impedance which matches an impedance of a host signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is an exploded perspective view schematically illustrating partial construction of an optical disc drive according to the present invention.

FIG. 1B is a bottom-view diagram of the optical disc drive in FIG. 1A according to the present invention.

FIGS. 2, 3A-3C, and 4-6 are functional diagrams illustrating an optical disc drive according to embodiments of the present invention.

FIGS. 7A and 7B are a cross-sectional diagram and a top-view diagram illustrating an embodiment of the signal transmitting medium according to the present invention.

FIGS. 8A-14A are cross-sectional diagrams illustrating configurations of the signal transmitting medium when trace-in.

FIGS. 8B-14B are cross-sectional diagrams illustrating configurations of the signal transmitting medium when trace-out.

FIGS. 15A-17A are top-view diagrams illustrating the configurations of the signal transmitting medium when trace-in.

FIGS. 15B-17B are top-view diagrams illustrating the configurations of the signal transmitting medium when trace-out.

### DETAILED DESCRIPTION

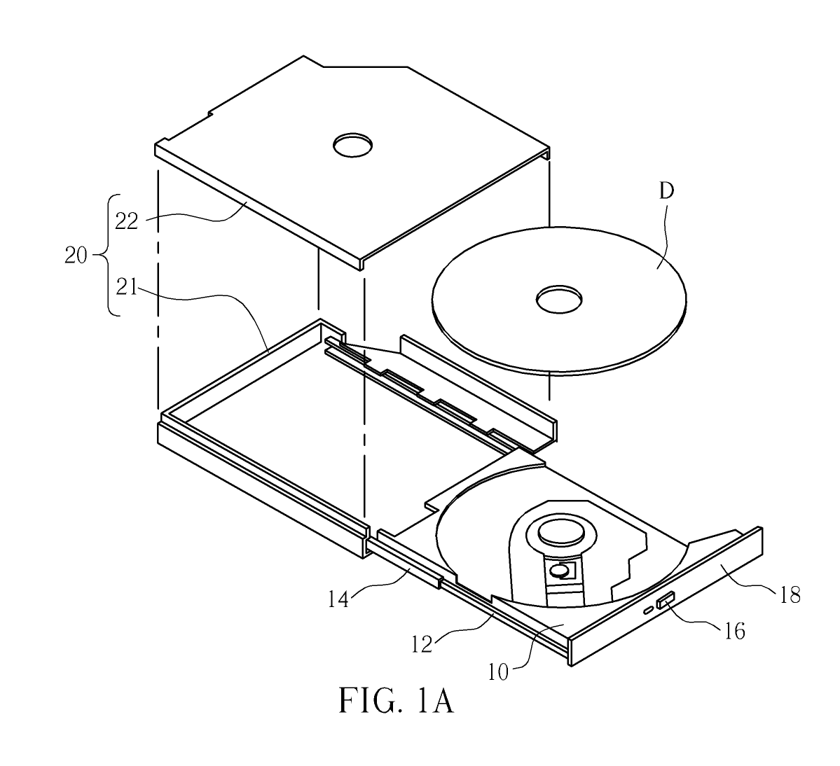

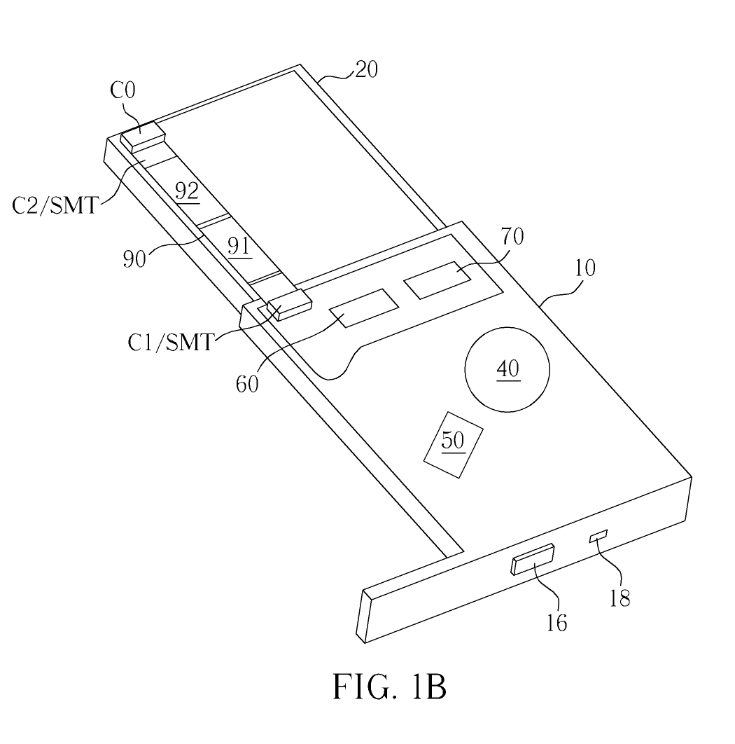

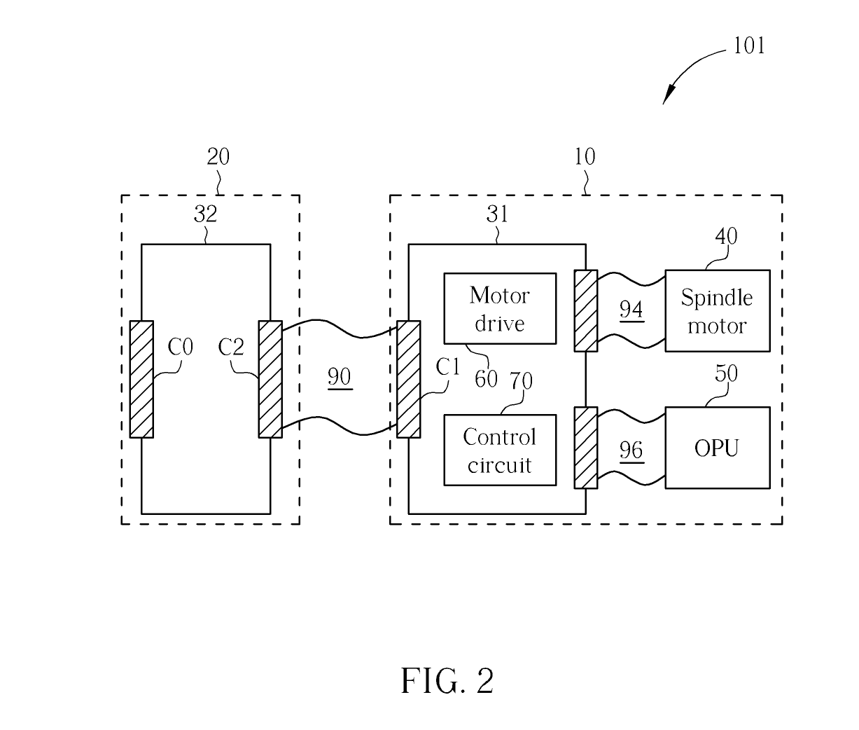

FIG. 1A is an exploded perspective view schematically illustrating partial construction of an optical disc drive according to the present invention. FIG. 1B is a bottom-view diagram of the optical disc drive according to the present invention. FIGS. 2, 3A-3C, and 4-6 are functional diagrams illustrating optical disc drives according to embodiments of the present invention.

Referring to FIG. 1A, the present optical disc drive includes a housing 20 having a lower case 21 and an upper case 22, and a disc tray 10 mounted in the housing 20 in a slidable manner. Tray guiding units for guiding the movement of the tray 10 may include rail assembling portions 12 formed at both sides of the disc tray 10 and sliding rails 14 slidably assembled with the rail assembling portions 12. A locking apparatus (not shown) is used to lock the disc tray 10 into the housing 20, and an ejector (not shown) is used to eject the disc tray 10 from the housing 20. An eject button 16 to operate the ejector is normally arranged on the front face bezel 18 of the disc tray 10. In a trace-out position when the disc tray 10 is ejected out of the housing 20, a disc D may be loaded. In a trace-in position when the disc tray 10 is pushed into the housing 20, data may be written into or read from the disc D according to host signals.

Referring to FIGS. 1B, 2, 3A-3C, and 4-6, each optical disc drive includes a disc tray 10, a housing 20, a spindle motor 40, an OPU 50, a motor drive 60, and a control circuit 70. The disc tray 10 may slide into or out of the housing 20 through its opening, as depicted in FIG. 1.

In FIG. 2, an optical disc drive 101 according to a first embodiment of the present invention is depicted. In this embodiment, a first circuit board 31 is assembled with the disc tray 10 and a second circuit board 32 is assembled with the housing 20. The spindle motor 40 is mounted on the disc tray 10 for spinning a disc. The OPU 50 is mounted on the disc tray 10 for recording or reproducing data from or onto the spinning disc. The motor drive 60 is mounted on the first circuit board 31 for operating the spindle motor 40. The control circuit 70 is mounted on the first circuit board 31 for providing intercommunication between the optical disc drive 101 and a host device (not shown) coupled to a high speed connector CO mounted on the second circuit board 32. The high speed connector CO, such as a SATA connector, is arranged for receiving host signals or transmitting device signals to the host.

Referring to FIG. 2, a signal transmitting medium 90, having one end attached to the first circuit board 31 and the other end attached to the second circuit board 32 through respective connectors C1 and C2 may transmit signals between the first circuit board 31 and the second circuit board 32. Also referring to FIG. 1B, a first portion 91 of the signal transmitting medium 90 may be floatingly disposed within the space between the lower case 21 and the upper case 22 of the housing 20, while a second portion 92 of the signal transmitting medium 90 may be fixed to the lower case 21 of the housing 20. It is noted that whether the first portion 91 or the second portion 92 is fixed (or both are fixed or both are floatingly disposed) can be flexible adjusted by the design conditions, such as the structure of housing 20 or material of the signal transmitting medium 90.

The signal transmitting medium 90 is configured to provide a signal transmission path having uniform impedance which matches that of the host signals, and will be described in more detail in subsequent paragraphs. A signal transmitting medium 94 is provided for transmitting signals between the first circuit board 31 and the spindle motor 40, while a signal transmitting medium 96 is provided for transmitting signals between the first circuit board 31 and the OPU 50. Since the connectors C0-C2 and the signal transmitting medium 90 are only required to transmit unprocessed host signals, the pin number of the connectors C0-C2 and the signal transmitting medium 90 may largely be reduced.

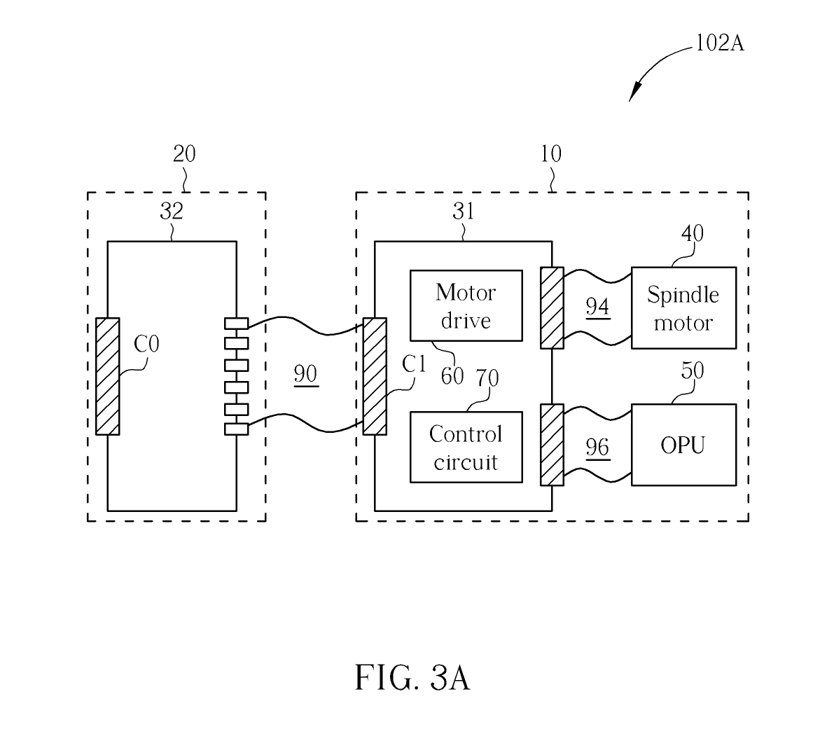

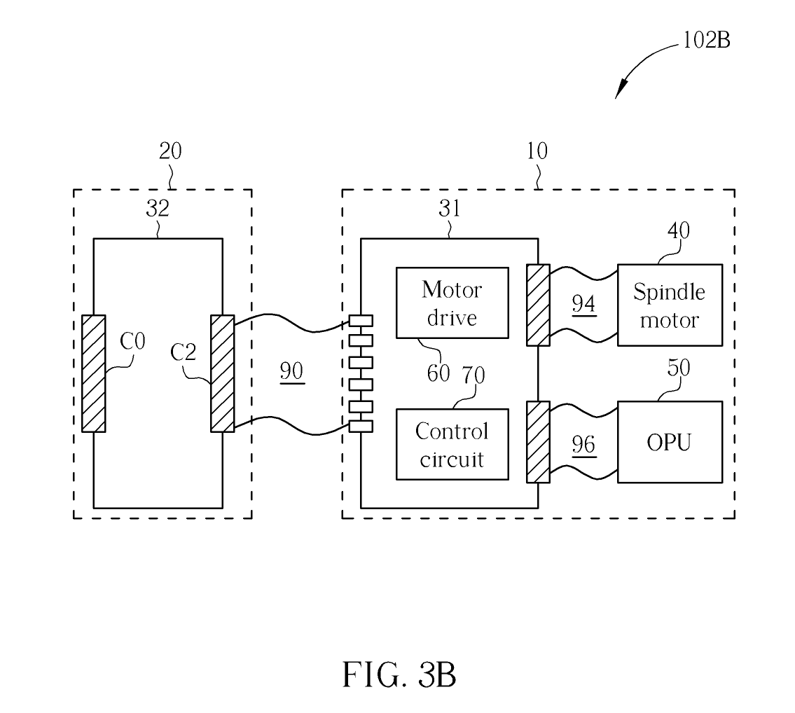

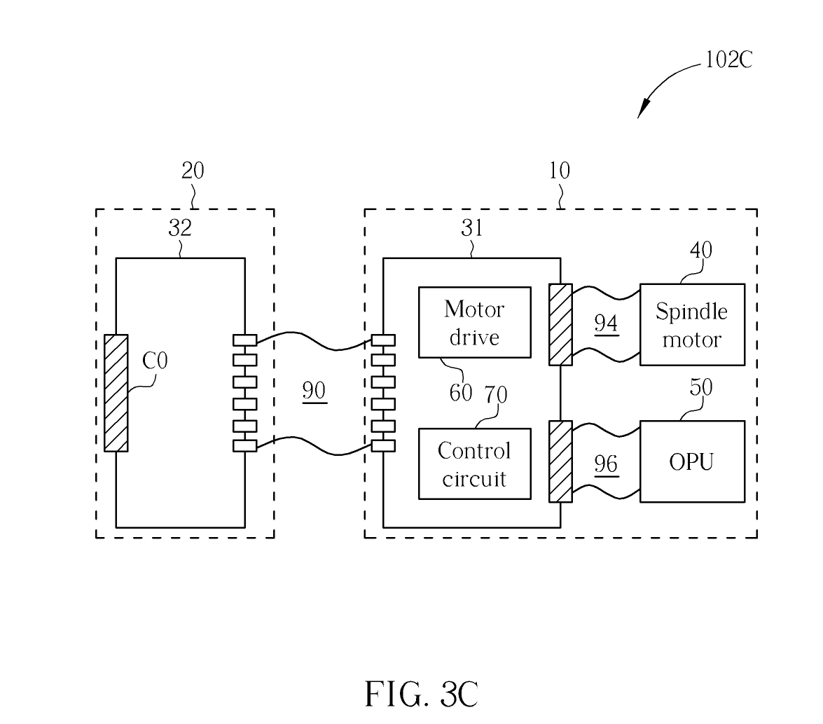

In FIGS. 3A-3C, optical disc drives 102A-102C according to a second embodiment of the present invention are depicted. Having similar structure as the first embodiment, the optical disc drive 102A differs from the optical disc drive 101 in that the signal transmitting medium 90 is directly attached to the second circuit board 32 by means of hot-bar surface mount technology (SMT). Having similar structure as the first embodiment, the optical disc drive 102B differs from the optical disc drive 101 in that the signal transmitting medium 90 is directly attached to the first circuit board 31 by means of hot-bar SMT. Having similar structure as the first embodiment, the optical disc drive 102C differs from the optical disc drive 101 in that the signal transmitting medium 90 is directly attached to the first circuit board 31 and the second circuit board 32 at both ends by means of hot-bar SMT. The introduction of hot-bar SMT may reduce the number of connectors required, thereby lowering manufacturing costs.

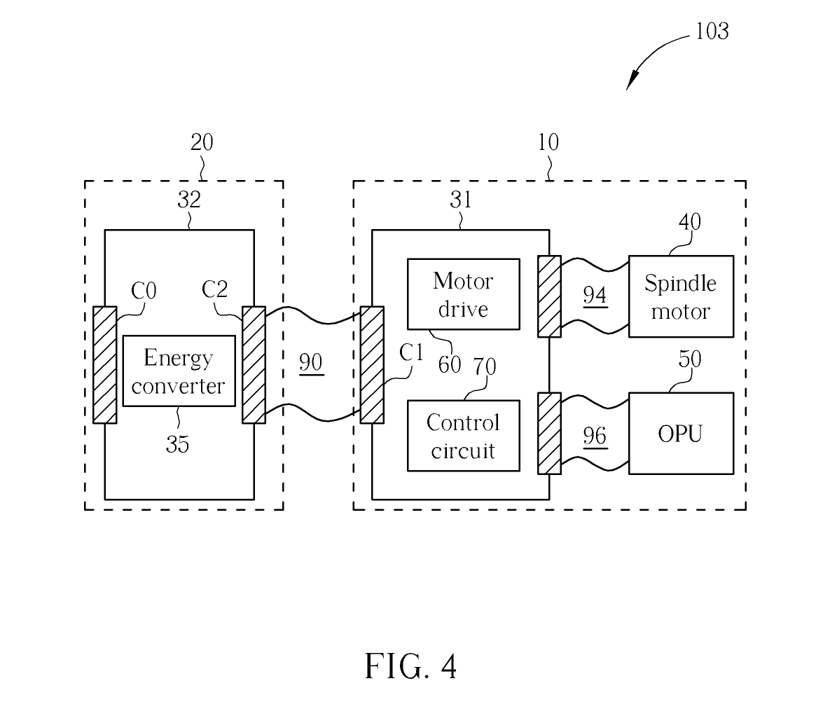

In FIG. 4, an optical disc drive 103 according to a third embodiment of the present invention is depicted. Having similar structure as the first embodiment, the optical disc drive 103 differs from the optical disc drive 101 in that an energy converter 35 is further provided. The energy converter 35, for example, may include an inductor or a capacitor configured to shift a frequency band having smaller return loss margin to another frequency band having larger return loss margin, thereby improving the overall return loss margin of the optical disc drive 103. It is noted that the energy converter 35 can be implemented at either/both side(s) of the signal transmitting medium 90, such as at the first circuit board 31 or at the second circuit board 32, or at both circuit boards 31 and 32. Similarly, the embodiments illustrated in FIGS. 2 and 3A-3C may also include the energy converter 35.

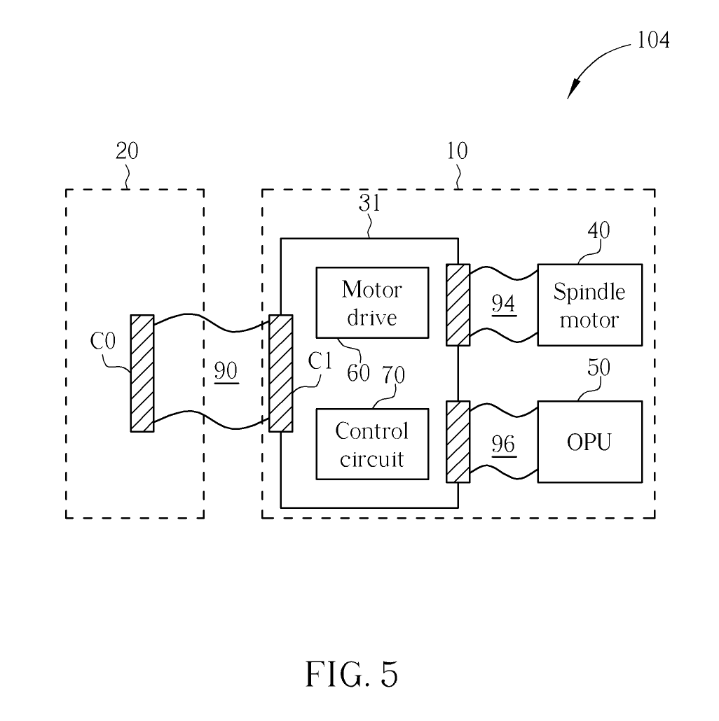

In FIG. 5, an optical disc drive 104 according to a fourth embodiment of the present invention is depicted. Having similar structure as the first embodiment, the optical disc drives 104 differs from the optical disc drive 101 in that the connector CO is directly mounted on the housing 20 without using the second circuit board 32, such as directly mounted on the lower case 21 of the housing 20 depicted in FIG. 1. Similarly, the connector CO in the embodiments illustrated in FIGS. 2, 3A-3C and 4 may also be directly mounted on the housing 20 without using the second circuit board 32. Since the second circuit board 32 is not required in this embodiment, the manufacturing costs may thus be lowered.

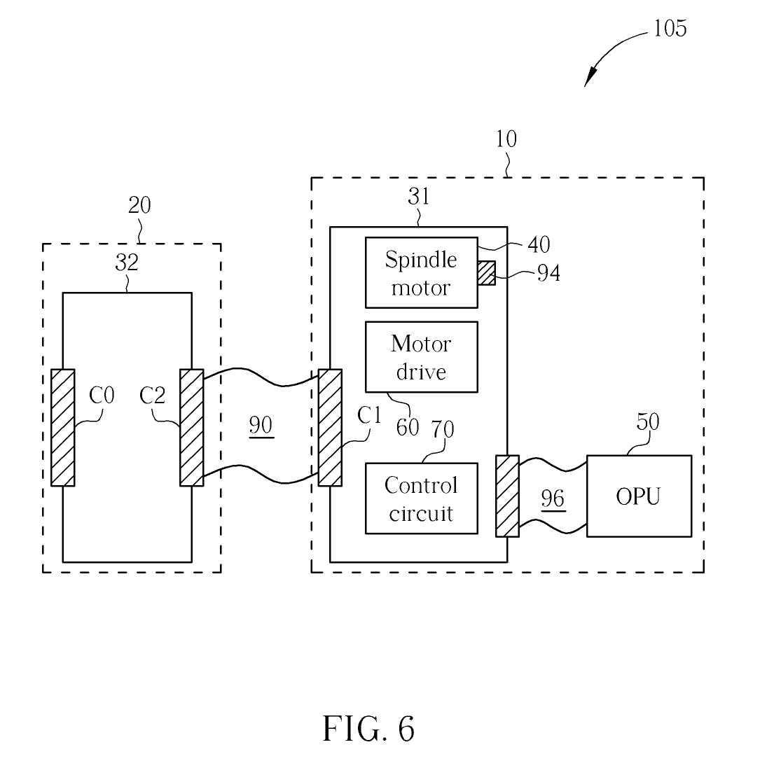

In FIG. 6, an optical disc drive 105 according to a fifth embodiment of the present invention is depicted. Having similar structure as the first embodiment, the optical disc drives 105 differs from the optical disc drive 101 in that the spindle motor 40 is mounted on the same first circuit board 31 together with the motor drive 60 and the control circuit 70. Similarly, the spindle motor 40 in the embodiments illustrated in FIGS. 2, 3A-3C and 4-5 may also be mounted on the same first circuit board 31 together with the motor drive 60 and the control circuit 70. Since the spindle motor 40 may be connected to the first circuit board 31 via a shorter signal transmitting medium 94 in this embodiment, the manufacturing costs may thus be lowered.

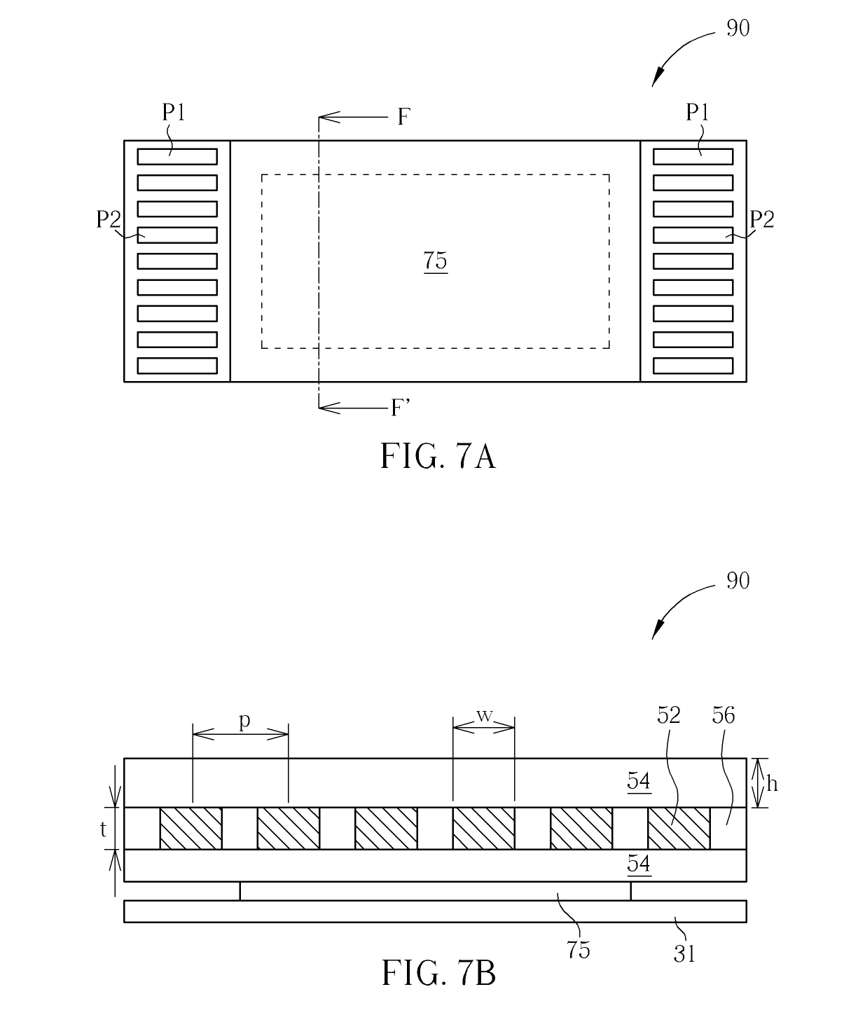

In the present invention, the signal transmitting medium 90 may adopt different types of flexible materials, such as flexible flat cable (FFC) or flexible printed circuit (FPC), which are easily bent and stretched in a narrow and crowded space. FIG. 7A is a bottom-view diagram illustrating the disposition of the signal transmitting medium 90 according to the present invention. FIG. 7B is a cross-sectional diagram along line F-F′ of the signal transmitting medium 90 in FIG. 7A.

Referring to FIG. 7B, the signal transmitting medium 90 may be fabricated by placing a plurality of metal traces 52 sandwiched between two isolating layers 54 and separated by insulating material 56. The impedance of the signal transmitting medium 90 may be determined by the pitch p (distance between centers of the adjacent metal traces 52), the trace width w, the trace thickness t, the dielectric constant (ε) and the thickness (h) of the isolating layers 54. Therefore, the signal transmitting medium 90 may provide a signal transmission path having impedance which matches that of the host signals by changing the above mentioned parameters p, w, t, ε and h. By impedance matching, the overall return loss margin of the optical disc drive may be improved for acquiring high-speed verification, such as passing SATA tests.

Referring to FIG. 7A, a plurality of pins are disposed at both sides of the signal transmitting medium 90 for signal transmission. An adhesive material 75, such as glue, is attached to the backside of the signal transmitting medium 90 so that the signal transmitting medium 90 may be attached to a circuit board, a housing or other structures. In the present invention, the adhesive material 75 may have a smaller surface area than that of the signal transmitting medium 90 for matching the overall impedance of the signal transmitting medium 90. For example, pin P1 provides a signal transmission path having impedance which is associated with the dielectric constant of the air, while pin P2 provides a signal transmission path having impedance which is associated with the dielectric constant of the adhesive material 75. The dielectric constant of the adhesive material 75 is larger than that of the air. Therefore, the present invention adopts the adhesive material 75 whose surface area is smaller than that of the signal transmitting medium 90, thereby capable of increasing the overall impedance of the signal transmitting medium 90 for impedance matching with the high-speed host signals.

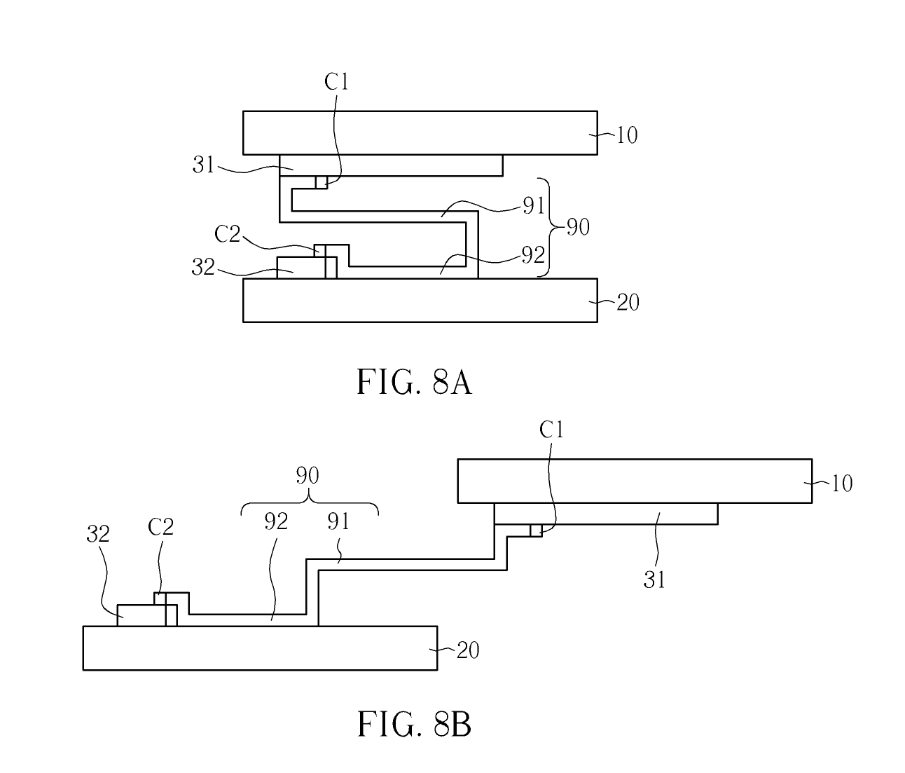

FIG. 8A is a cross-sectional diagram illustrating a first configuration of the signal transmitting medium 90 when trace-in, and FIG. 8B is a cross-sectional diagram illustrating the first configuration of the signal transmitting medium 90 when trace-out. In this configuration, the signal transmitting medium 90 includes a first end attached to the first circuit board 31 via the connector C1 (or by hot-bar SMT), a second end attached to the second circuit board 32 (or directly attached to the housing 20) via the connector C2 (or by hot-bar SMT), a stretchable first portion 91, and a second portion 92 fixed to the housing 20. Therefore, no matter whether the movable disc tray 10 is positioned in or out, the host signals can still reach the first circuit board 31. Since the first portion 91 is disposed in a floating manner, it may be in contact with the second portion 92 when trace-in, thereby changing its impedance. Since the second portion 92 is attached to the housing 20, the host signals encounter smaller impedance when passing through the second portion 92. In order for the signal transmitting medium 90 to provide uniform impedance when the host signals pass through the first portion 91 and the second portion 92, the present invention may increase the thickness h of the isolating layers 54 in FIG. 7 for improving the impedance issue and/or getting better noise shielding.

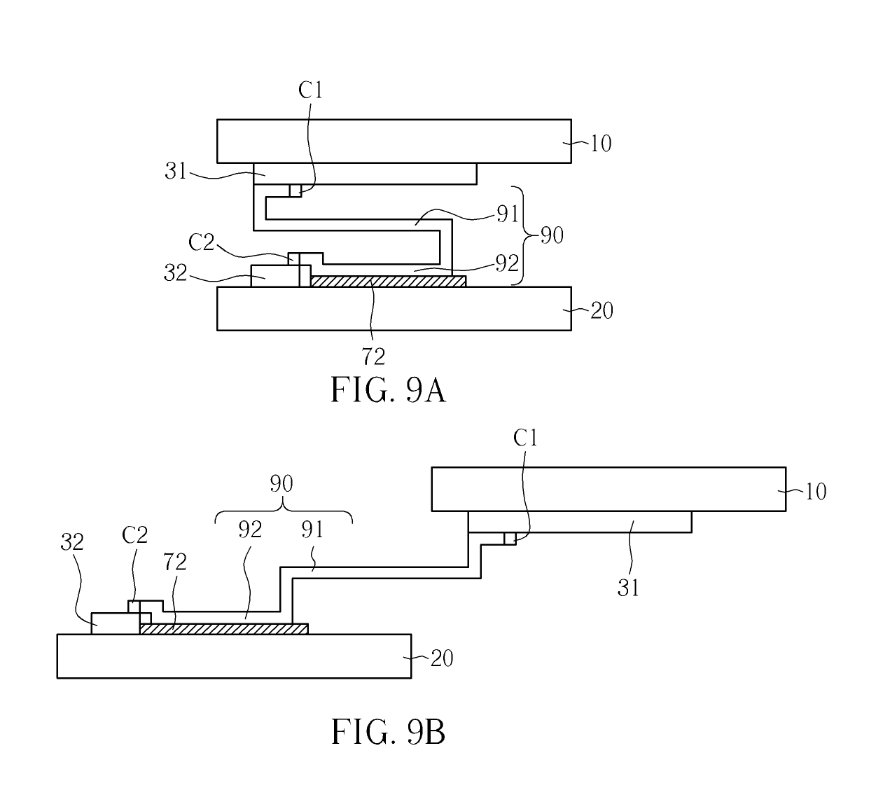

FIG. 9A is a cross-sectional diagram illustrating a second configuration of the signal transmitting medium 90 when trace-in, and FIG. 9B is a cross-sectional diagram illustrating the second configuration of the signal transmitting medium 90 when trace-out. In this configuration, a protection layer 72 is further provided between the second portion 92 and the housing 20 for improving the impedance issue and/or getting better noise shielding.

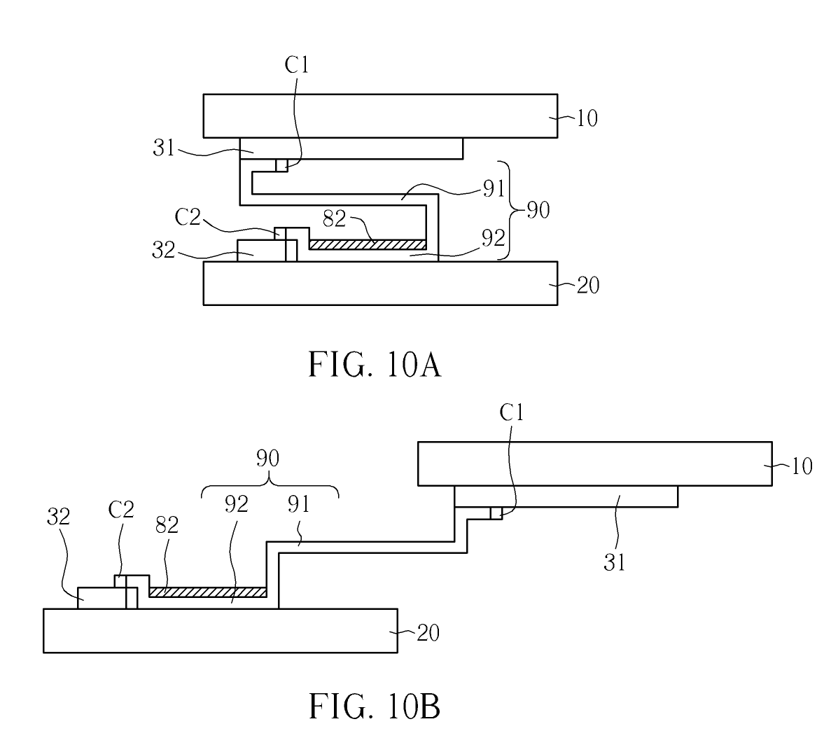

FIG. 10A is a cross-sectional diagram illustrating a third configuration of the signal transmitting medium 90 when trace-in, and FIG. 10B is a cross-sectional diagram illustrating the third configuration of the signal transmitting medium 90 when trace-out. In this configuration, a protection layer 82 is further provided between the first portion 91 and the second portion 92 for improving the impedance issue and/or getting better noise shielding.

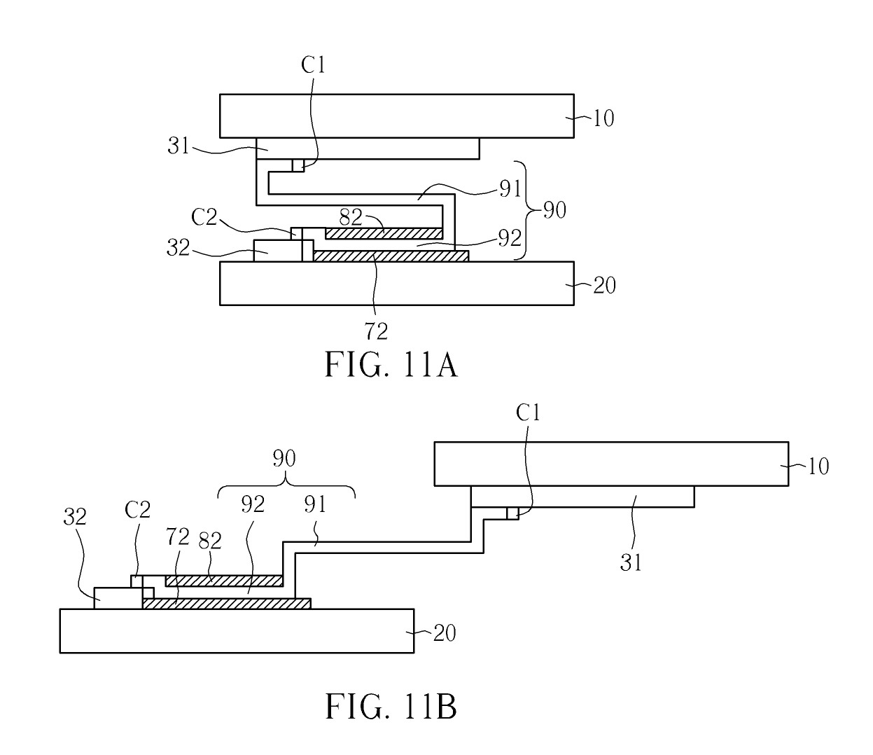

FIG. 11A is a cross-sectional diagram illustrating a fourth configuration of the signal transmitting medium 90 when trace-in, and FIG. 11B is a cross-sectional diagram illustrating the fourth configuration of the signal transmitting medium 90 when trace-out. In this configuration, a protection layer 72 is further provided between the second portion 92 and the housing 20 and a protection layer 82 is further provided between the first portion 91 and the second portion 92 for improving the impedance issue and/or getting better noise shielding.

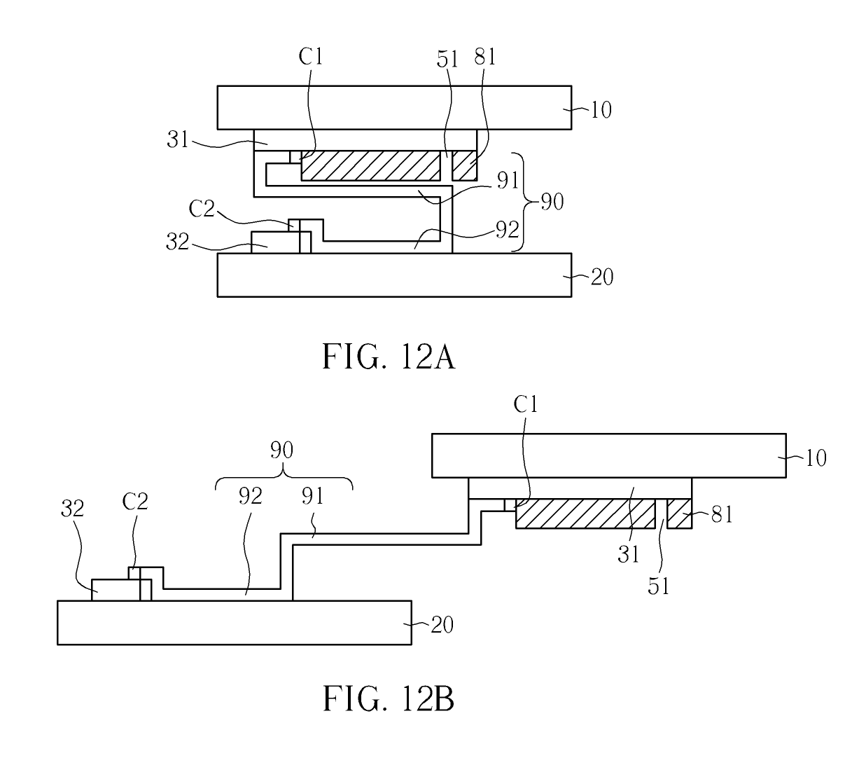

FIG. 12A is a cross-sectional diagram illustrating a fifth configuration of the signal transmitting medium 90 when trace-in, and FIG. 12B is a cross-sectional diagram illustrating the fifth configuration of the signal transmitting medium 90 when trace-out. In this configuration, a metal tray cover 81 is further provided between the first circuit board 31 and the first portion 91. When trace-in, the signal transmitting medium 90 occupies larger space between the housing 20 and the disc tray 10 near the intersection of the first portion 91 and the second portion 92. Therefore, the metal tray cover 81 may have reduced thickness near the intersection of the first portion 91 and the second portion 92 in order to prevent the signal transmitting medium 90 from contacting the metal tray cover 81 near the intersection of the first portion 91 and the second portion 92 when trace-in, thereby decreasing the impedance variation of the signal transmitting medium 90 between trace-in and trace-out positions. For example, the metal tray cover 81 may further include an opening 51 at a location corresponding to the intersection of the first portion 91 and the second portion 92.

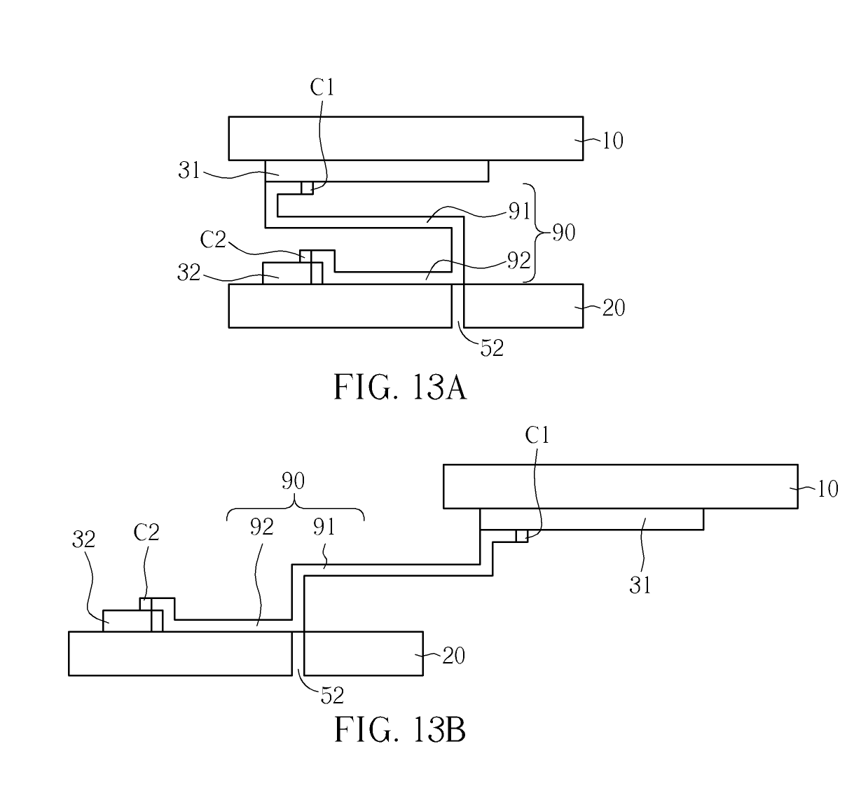

FIG. 13A is a cross-sectional diagram illustrating a sixth configuration of the signal transmitting medium 90 when trace-in, and FIG. 13B is a cross-sectional diagram illustrating the sixth configuration of the signal transmitting medium 90 when trace-out. When trace-in, the signal transmitting medium 90 occupies larger space between the housing 20 and the disc tray 10 near the intersection of the first portion 91 and the second portion 92. Therefore, the thickness of the housing 20 near the intersection of the first portion 91 and the second portion 92 may be reduced in order to prevent the signal transmitting medium 90 from contacting the housing 20 near the intersection of the first portion 91 and the second portion 92 when trace-in, thereby decreasing the impedance variation of the signal transmitting medium 90 between trace-in and trace-out positions. For example, the housing 20 may further include an opening 52 at a location corresponding to the intersection of the first portion 91 and the second portion 92.

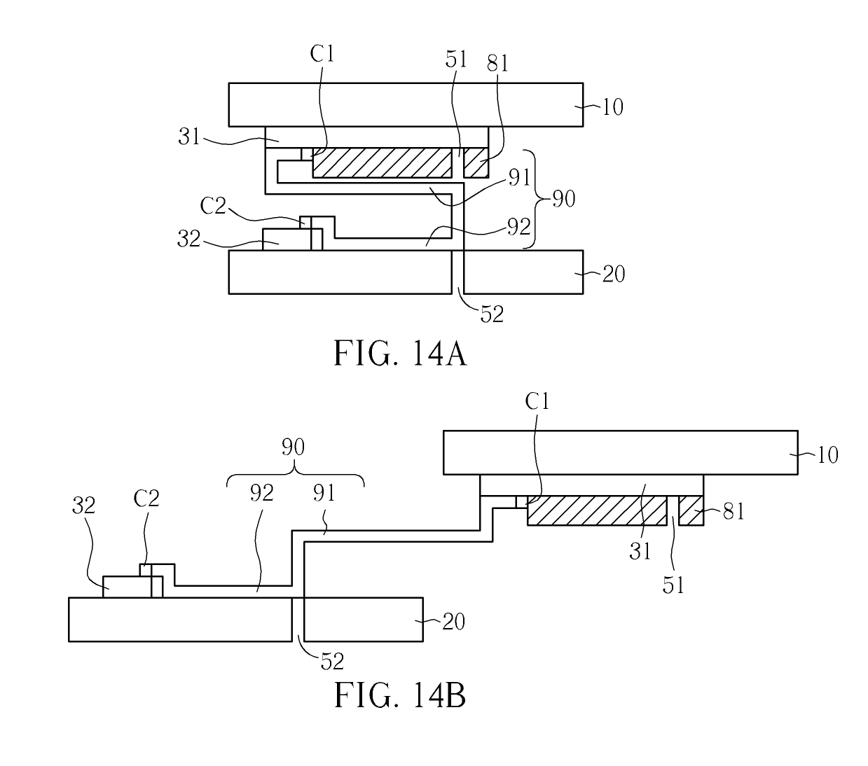

FIG. 14A is a cross-sectional diagram illustrating a seventh configuration of the signal transmitting medium 90 when trace-in, and FIG. 14B is a cross-sectional diagram illustrating the seventh configuration of the signal transmitting medium 90 when trace-out. In this configuration, a metal tray cover 81 is provided between the first circuit board 31 and the first portion 91. When trace-in, the signal transmitting medium 90 occupies larger space between the housing 20 and the disc tray 10 near the intersection of the first portion 91 and the second portion 92. Therefore, the metal tray cover 81 and the housing 20 may have reduced thickness near the intersection of the first portion 91 and the second portion 92 in order to prevent the signal transmitting medium 90 from contacting the metal tray cover 81 or the housing 20 near the intersection of the first portion 91 and the second portion 92 when trace-in, thereby decreasing the impedance variation of the signal transmitting medium 90 between trace-in and trace-out positions. For example, the metal tray cover 81 may further include an opening 51 and the housing 20 may further include an opening 52 at locations corresponding to the intersection of the first portion 91 and the second portion 92.

In FIGS. 12A-12B and 14A-14B, 51 or 52 is depicted as an opening. However, 51 or 52 may also be a dent so that the metal tray cover 81 or the housing 20 is thinner at a location corresponding to the intersection of the first portion 91 and the second portion 92.

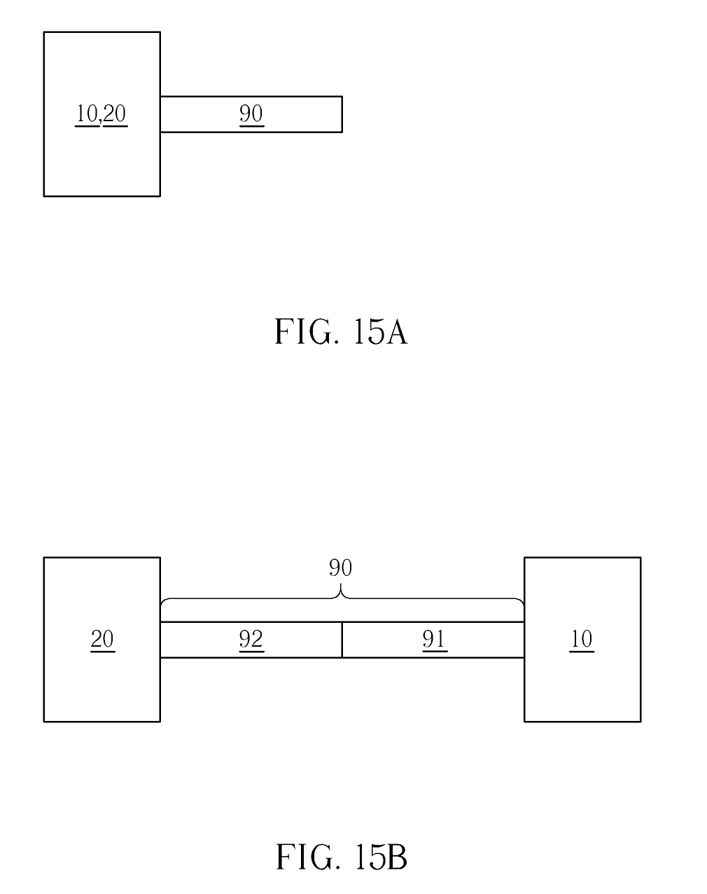

FIGS. 15A-17A are top-view diagrams illustrating the first to seventh configurations of the signal transmitting medium 90 when trace-in, and FIGS. 15B-17B are top-view diagrams illustrating the first to seventh configurations of the signal transmitting medium 90 when trace-out. In FIGS. 15A and 15B, the signal transmitting medium 90 includes a first end connected to the disc tray 10 either via the connector C1 or by hot-bar SMT; a second end connected to the housing 20 either via the connector C2 or by hot-bar SMT; a stretchable first portion 91 and a second portion 92 fixed to the housing 20. Since the first portion 91 and the second portion 92 are completely overlapped when trace-in, the configurations illustrated in FIGS. 8A-14A and 8B-14B may be implemented for better noise shielding, such as by increasing the thickness h of the isolating layers 54, introducing the protection layer 72 or/and 82, or reducing the thickness of the metal tray cover 81 or/and the housing 20 near the intersection of the first portion 91 and the second portion 92.

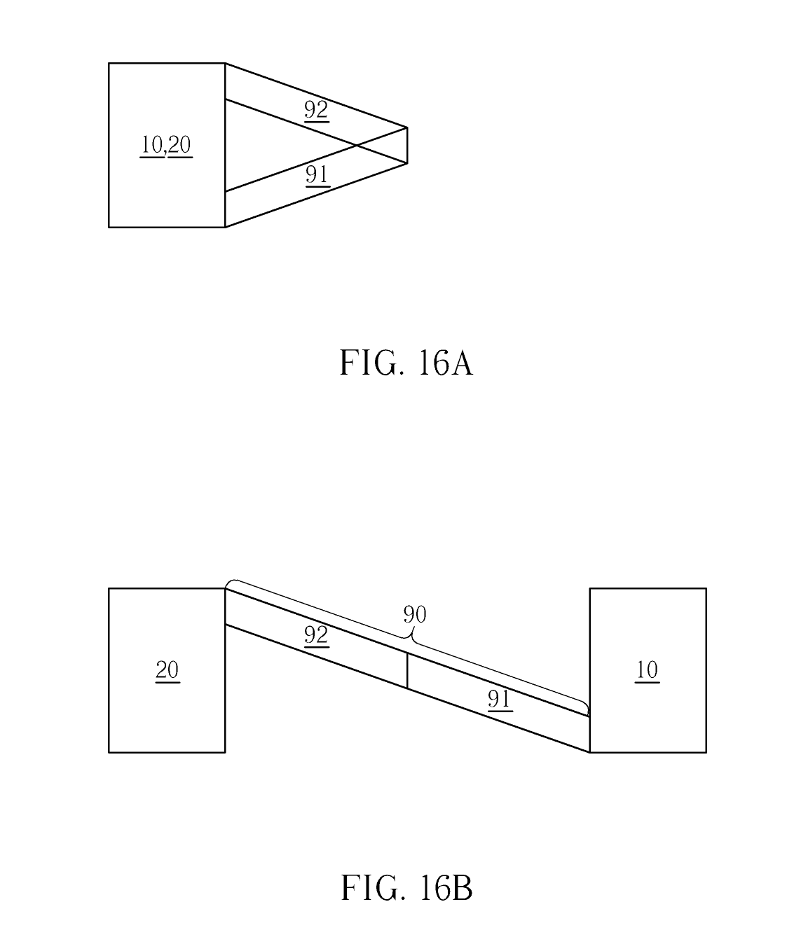

In FIGS. 16A and 16B, the signal transmitting medium 90 includes a first end connected to the disc tray 10 either via the connector C1 or by hot-bar SMT, a second end connected to the housing 20 either via the connector C2 or by hot-bar SMT, a stretchable first portion 91, and a second portion 92 fixed to the housing 20. Meanwhile, the signal transmitting medium 90 is arranged so that the first portion 91 and the second portion 92 are overlapped only near the intersection of the first portion 91 and the second portion 92 when trace-in, thereby decreasing signal coupling and improving signal quality. Meanwhile, the configurations illustrated in FIGS. 8A-14A and 8B-14B may also be implemented for further improving impedance matching or noise shielding, such as by increasing the thickness h of the isolating layers 54, introducing the protection layer 72 or/and 82, or reducing the thickness of the metal tray cover 81 or/and the housing 20 near the intersection of the first portion 91 and the second portion 92.

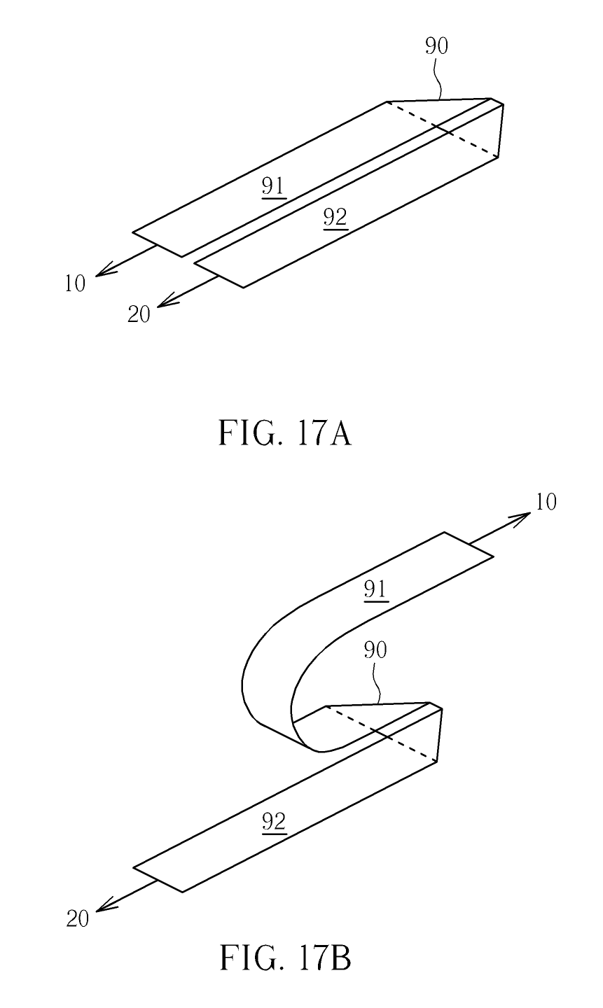

In FIGS. 17A and 17B, the signal transmitting medium 90 includes a first end connected to the disc tray 10 either via the connector C1 or by hot-bar SMT, a second end connected to the housing 20 either via the connector C2 or by hot-bar SMT, a stretchable first portion 91, and a second portion 92 fixed to the housing 20. Meanwhile, the signal transmitting medium 90 is arranged so that the first portion 91 and the second portion 92 are not overlapped when trace-in, thereby decreasing signal coupling and improving signal quality. Meanwhile, the configurations illustrated in FIGS. 8A-14A and 8B-14B may also be implemented for further improving impedance matching or noise shielding, such as by increasing the thickness h of the isolating layers 54, introducing the protection layer 72 or/and 82, or reducing the thickness of the metal tray cover 81 or/and the housing 20 near the intersection of the first portion 91 and the second portion 92.

In the present invention, the control circuit 70 may further include an adjustable termination for impedance matching, thereby improving the overall return loss margin. Meanwhile, the control circuit 70 may be packaged as an IC having shorter lead frames than bonding wires for improving the overall return loss margin.

In the present invention, a plurality of connectors and a stretchable signal transmitting medium are used for transmitting host signals from a housing to a slideable disc tray. Then, a control circuit installed on the disc tray may process host signals for operating a spindle motor and an OPU accordingly. Since the connectors and the signal transmitting medium are only required to transmit unprocessed host signals, the pin number of the connectors, cables or the signal transmitting medium may largely be reduced. Also, the present signal transmitting medium is configured to provide a signal transmission path between the housing and the disc tray and having an impedance which matches that of the host signals. Therefore, the present invention can improve the overall return loss margin of the optical disc drive. The present invention may be applied to various types of optical disc drives, particularly to slim-type optical disc drives.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical disc drive, comprising:
a housing;
a disc tray capable of sliding into and out of the housing;
a first circuit board on the disc tray;
a first connector on the housing for receiving a host signal;
a control circuit on the first circuit board for processing the host signal; and
a signal transmitting medium electrically interconnected between the first connector and the first circuit board.

2. The optical disc drive of claim 1, further comprising:
a spindle motor on the disc tray for spinning a disc;
an optical pickup unit on the disc tray for accessing data from the disc; and
a motor drive on the disc tray for operating the spindle motor.

3. The optical disc drive of claim 2, wherein the spindle motor, the OPU and the control circuit are on the first circuit board.

4. The optical disc drive of claim 1, further comprising:
a second circuit board on the housing for containing the first connector.

5. The optical disc drive of claim 4, wherein the signal transmitting medium includes:
a first end attached to the first circuit board via a second connector or by means of a hot-bar surface mount technology (SMT); and
a second end attached to the second circuit board via a third connector or by means of the hot-bar SMT.

6. The optical disc drive of claim 5, wherein the signal transmitting medium further includes:
a stretchable first portion;
a second portion fixed to the housing; and
a protection layer disposed between the first portion and the second portion, or between the second portion and the housing.

7. The optical disc drive of claim 6, further comprising a metal tray cover disposed between the first circuit board and the first portion, wherein the metal tray cover has a reduced thickness at a location corresponding to an intersection of the first portion and the second portion.

8. The optical disc drive of claim 6, wherein the housing includes an opening or a dent at a location corresponding to an intersection of the first portion and the second portion.

9. The optical disc drive of claim 6, further comprising:
an adhesive material attached to a backside of the signal transmitting medium for fixing the first portion to the housing, wherein the adhesive material has a surface area smaller than that of the first portion.

10. The optical disc drive of claim 1, wherein the signal transmitting medium is arranged so that the first portion and the second portion are overlapped only near an intersection of the first portion and the second portion when the disc tray is positioned inside the housing.

11. The optical disc drive of claim 1, wherein the signal transmitting medium includes a plurality of metal traces sandwiched between two isolating layers and separated by a plurality of insulating materials, wherein a pitch between the metal traces, a width of the metal traces, a thickness of the metal traces, a thickness of the isolating layers, and a dielectric constant of the isolating layers are presented so as to provide a signal transmission path between the first connector and the first circuit board and having an impedance which matches an impedance of the host signal.

12. The optical disc drive of claim 1, further comprising an energy converter configured to increase a return loss margin by shifting frequencies.

13. The optical disc drive of claim 1, wherein the control circuit comprises an adjustable termination for impedance matching.

14. An optical disc drive, comprising:
a housing;
a disc tray capable of sliding into and out of the housing; and
a signal transmitting medium configured to provide a signal transmission path between the housing and the disc tray and having an impedance which matches an impedance of a host signal.

15. The optical disc drive of claim 14, wherein the signal transmitting medium includes:
a first end coupled to the disc tray;
a second end coupled to the housing;
a stretchable first portion;
a second portion fixed to the housing; and
a protection layer disposed between the first portion and the second portion, or between the second portion and the housing.

16. The optical disc drive of claim 15, wherein the housing includes an opening or a dent at a location corresponding to an intersection of the first portion and the second portion.

17. The optical disc drive of claim 15, further comprising a metal tray cover disposed between the disc tray and the first portion, wherein the metal tray cover has a reduced thickness at a location corresponding to an intersection of the first portion and the second portion.

18. The optical disc drive of claim 15, further comprising:
an adhesive material attached to a backside of the signal transmitting medium for fixing the first portion to the housing, wherein the adhesive material has a surface area smaller than that of the first portion.

19. The optical disc drive of claim 14, wherein the signal transmitting medium includes a plurality of metal traces sandwiched between two isolating layers and separated by a plurality of insulating materials, wherein a pitch between the metal traces, a width of the metal traces, a thickness of the metal traces, a thickness of the isolating layers, and a dielectric constant of the isolating layers are presented so as to match the impedance of the signal transmission path to the host signal.

20. The optical disc drive of claim 14, wherein the signal transmitting medium is arranged so that the first portion and the second portion are overlapped only near an intersection of the first portion and the second portion when the disc tray is positioned inside the housing.
